(19) United States
(12) Patent Application Publication
(10) Pub. No.: US 2025/0381678 A1
(43) Pub. Date: Dec. 18, 2025

(54) System for Firefighting and HAZMAT Manned-Unmanned Teaming Dual Use

(71) Applicant: Bora F. Aykin, Matawan, NJ (US)

(72) Inventor: Bora F. Aykin, Matawan, NJ (US)

(21) Appl. No.: 19/000,230

(22) Filed: Mar. 7, 2025

(51) Int. Cl. B25J 11/00; B25J 19/02

(52) U.S. Cl. CPC B25J 11/009; B25J 11/0025; B25J 19/023

(57) ABSTRACT

A system for a manned-unmanned teaming platform (MUM-T) for firefighting, search, rescue, and performing autonomously or remote-controlled HAZMAT tasks (“Tasks”). Interfacing with this system, a unit that can be body worn by a firefighter, remotely controlled by an operator or entirely autonomous by itself with a combination of a microprocessor, cameras that broadcast both video feed, RF telemetry with global positioning system (GPS) location as well as using rangefinders and received signal strength index (RSSI) triangulation for keeping track of the location of the operator.

### BACKGROUND

In general, structural firefighting as well as the related field of search and rescue involve operating in environments that are immediately dangerous to life and health (IDLH) of firefighters and those who need to be rescued. Many tasks in structural firefighting such as tactical vertical ventilation, search and rescue, forcible entry, and fire suppression all come with fire, structural collapse, toxic byproducts, and other imminent environmental dangers. Unmanned vehicles help mitigate this risk by reducing the time and number of personnel needed in an IDLH environment.

In modern structural firefighting, a personal alert safety system (PASS) alarm is worn by every firefighter. It usually contains an accelerometer that will set off an audible siren after 30 seconds of sensing no motion from a firefighter or can be manually activated via a user-controlled switch. However, modern PASS alarms do not give precise location information, nor do they allow other firefighters to see the “point of view” of the firefighter who is in trouble. The scope of this invention is to replace and surpass current PASS alarm technology by adding 3rd person video feed and precision location as well as having a platform for unmanned vehicle operation in the same device.

One potential application of MUM-T is firefighting, search and rescue, and performing autonomously or remote-controlled HAZMAT tasks fields. With the proliferation of unmanned aerial vehicle system (UAVS) and other unmanned vehicles, the benefits of a life safety grade manned-unmanned system with redundancy to the fire rescue service cannot be understated.

Long wave infrared (LWIR) commonly known as thermal imaging, is an integral part of the fire service's tactical array of equipment for many different scenarios. Night Vision and regular day cameras are used both for manned and unmanned purposes. Both manned and unmanned long-range units are commonly available for LWIR, night vision, and day vision. Furthermore, they come in both digital and analog versions with both types of interfaces are included in the design for redundancy.

This invention pertains to a system that seamlessly allows transition from a body mounted thermal camera to a unmanned mounted one with software defined radio computer numerical control (CNC) over the vehicle with long range imaging as well as manned body worn live video feed. Since the device contains at least one microprocessor and at least one microcontroller, it enables multiple sensors, at least one GPS, radio frequency (RF) control, navigation systems, 3D modeling with rangefinders including laser (LIDAR), ultrasonic (SONAR, radio (RADAR) and triangulation of RF RSSI recorder and signal rangefinders.

Since it is life safety technology, the concepts of redundancy and compartmentalized failure apply to this design.

### SUMMARY OF INVENTION

In one embodiment, the system of this invention consists of:
One or more offline power sources (e.g. batteries, solar panels, or others)
One or more DC-DC buck converter or other isolation DC-DC power supply
One or more backup offline power supply
One or more microprocessors
One or more mounted multichannel display (e.g. helmet or other medium mounted or unmounted receiver)
Multiple receivers
One or more detachable MUM-T module with both digital and analog thermal and adaptive night vision
One or more remote controller module
One or more GPS/GLONASS and other navigation systems for both the remote controller and MUM-T unit
Multi-band, multi-protocol RF transceivers for telemetry and remote control with designated frequencies and channels for a distress call (MAYDAY) and other emergency traffic
A quick disconnect mount that the firefighter can detach the body worn module
One or more multi-band video transmitters with designated frequencies and channels for MAYDAYs and other emergency traffic
One or more microcontrollers with both analog and digital input/output ports
One or more remote command post with ability to monitor several video channels simultaneously
One or more unmanned vehicles (e.g. aerial, ground, waterborne unmanned vehicles) with a matching mount for the MUM-T unit.
One or more high density connectors to match both the unmanned unit and the MUM-T unit
A user interface to set waypoints with the navigation system on both the manned controller and a vehicle mounted MUM-T unit

The MUM-T unit contains one or more of each of the following: i) analog LWIR thermal camera, ii) digital LWIR thermal camera, iii) analog night vision camera, iv) digital night vision camera, and v) analog and digital cameras. For the digital cameras the signal is converted by the microprocessor on board to an analog signal, and both the converted analog and digital signals are fed into a multiplexer multi-transmitter array of line drivers. The output of the video line drivers is fed to at least one but preferably multiple video transmitters of varying bands and protocols.

Microcontrollers are linked to both multiple GPS units and multiple RF transceivers for telemetry and remote control. The duplex RF transceivers are used for remote control commands, telemetry, transmitting GPS and other environmental data. In addition, RSSI is used to triangulate the location of the MUM-T node for redundancy and additional geospatial information to the GPS. The module contains one or more primary, and one or more backup power supply for redundancy.

There are two main configurations that the manned-unmanned camera-controller module can be configured for in the field. It can either be manned including but not limited to body worn, helmet mounted, equipment (e.g. hose) mounted or remote controlled, or unmanned and autonomous including but not limited to unmanned aerial, terrestrial, or waterborne vehicles, or any combination of these. The firefighter can detach a unit from a vehicle and mount it on their turnout gear or detach a body worn unit and mount it in the field with a quick disconnect mounting system. The high-density connector is preferably wired to several digital general-purpose input/output (GPIO) pins.

The compatible unmanned vehicle has a microcontroller with its own matching RF transceivers for telemetry and remote control as well as having a matching high density connector for a wired connection with the MUM-T module.

For the remote-controlled embodiment, firefighters have a controller module if they have an unmanned vehicle with them in the field. The controller itself has a microcontroller, a user interface for controls and matching RF transceivers for the MUM-T camera-controller module. This can be used for sensors and three-way connections between the controller interface, the MUM-T camera interface, and the unmanned vehicle's chassis. Alternatively, the unmanned vehicle's chassis may be independent with the MUM-T unit mounted simply for geospatial information (e.g. GPS, triangulation, etc.) and long-range imaging. For semi-autonomous and autonomous embodiments, the operator would enter parameters, and the CNC unmanned vehicle will autonomously navigate and operate accordingly. In one embodiment, this would consist of the operator entering locations as waypoints and the unmanned CNC vehicle navigating to the locations entered.

In addition, it allows for 3rd person “buddy” viewing, command and control remote monitoring for “point of view” of subordinates, and as a video feed in a MAYDAY or firefighter down scenario. In this case, the telemetry lines will be used to broadcast GPS location information, rangefinder information that maps out obstacles.

Furthermore, failure of any component, protocol, frequency, etc. will be compartmentalized and with secondary and tertiary backup. The device would be either permanently mounted on the body of fire rescue personnel and unmanned vehicles or would have a quick release system.

The device would also be outfitted to switch between air cooling, off of respirators, and liquid cooling while mounted on a vehicle. While in manned configuration and body worn, air from the SCBA is used to cool the circuit components while internal sensors monitor flow and pressure of air to keep track of the firefighter's air consumption and remaining supply, respectively. In unmanned configuration, the MUM-T module can be connected to an external water pump and radiator setup with an active heat exchange for water cooling. The same quick disconnect fittings and hardware can be used for both configurations.

### BRIEF DESCRIPTION OF THE DRAWINGS

FIG. 1 depicts a top-level strategic diagram of the interactions between MUM-T interface modules, firefighters, unmanned vehicle operators, and unmanned vehicles.

FIG. 2 depicts a generic circuit diagram for the MUM-T module interface that is compatible with both manned and unmanned configurations

FIG. 3 depicts the remote-control interface with which an operator can control a CNC unmanned vehicle and it's attachments

FIG. 4 depicts the generic circuit diagram for the unmanned CNC vehicle.

FIG. 5 depicts the receiver and display interface for firefighters, operators, and remote command centers.

FIG. 6 depicts a functional block diagram showing the RF interactions with the manned configuration as well as different unmanned configurations for the MUM-T interface module and channel allocation.

FIG. 7 depicts a comparison block diagram showing the different types of functionalities available in different configurations.

FIG. 8 depicts a top-level strategic diagram showing the interactions between a remote command post tracking several interior firefighters.

FIG. 9 depicts an unmanned CNC vehicle setting a waypoint for other firefighters with telemetry and triangulation (RF and rangefinder).

FIG. 10 depicts a MAYDAY situation where both firefighters and unmanned vehicles track and respond to a firefighter in distress.

### DETAILED DESCRIPTION

The MUM-T interface is a dual use unit that offers both manned and unmanned configurations for the same firefighting system. It's capabilities at minimum to include thermal imaging, adaptive night vision, geospatial information, telemetry, RSSI signal triangulation, remote control and waypoints for unmanned operations, and MAYDAY capabilities for manned body worn operation. Life safety features include redundancy for imaging an RF transmission, multiplexed ports, direct and backup power supplies, and compartmentalized design features. Manned MAYDAY capabilities build on existing PASS alarm technology and can be triggered automatically or manually by the operator. Unmanned configurations include wired and wireless interfaces, autonomous and remote-control operation capabilities, and reduced feature mode for systems that have their own navigational properties. In case the unmanned vehicle has an incompatible system like its own remote-control setup, the device can still be mounted for camera, geospatial, and environmental sensor information without directly controlling the unmanned vehicle.

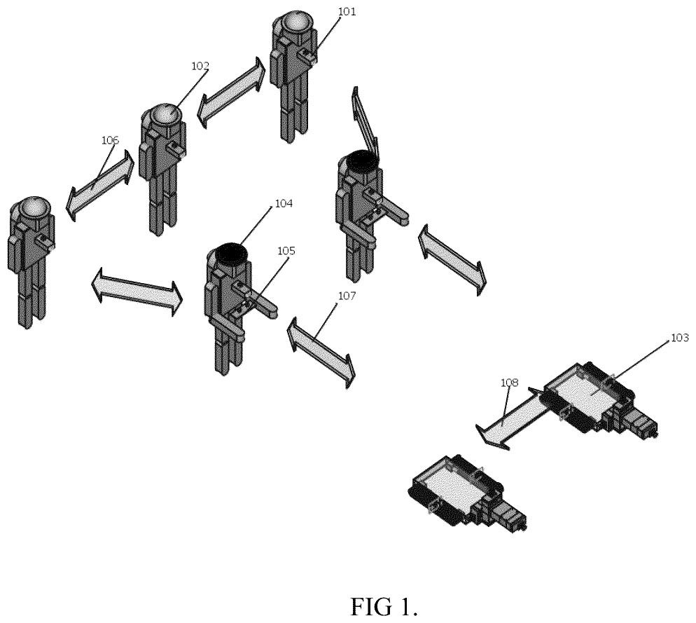

FIG. 1 depicts a high-level strategic diagram of routine non-emergency, non-MAYDAY interactions between the MUM-T nodes. The nodes consist of the MUM-T microprocessor interface 101 that can be either body mounted or otherwise manned (e.g. tool mounted) by a first responder equipped with a heads-up display (HUD) with 102 in the manned configuration. It can be mounted on an unmanned vehicle 103 in the unmanned remote configuration. Properly trained emergency personnel are designated as drone operators 104 and have user controller modules 105 for remote control, semi-autonomous, or full autonomous operation of unmanned vehicles. The unmanned vehicles are capable of navigation as well as tool attachment positioning and operation. Attachments include but are not limited to saws, hydraulic tools and hoses. RF and video transmissions between nodes are preferably duplex and multi-band as well as multi-channel for redundancy with certain channels designated for MAYDAY and emergency traffic. The RF and video interactions can be duplex from personnel to personnel 106, personnel to unmanned vehicle 107, and unmanned vehicle to unmanned vehicle 108.

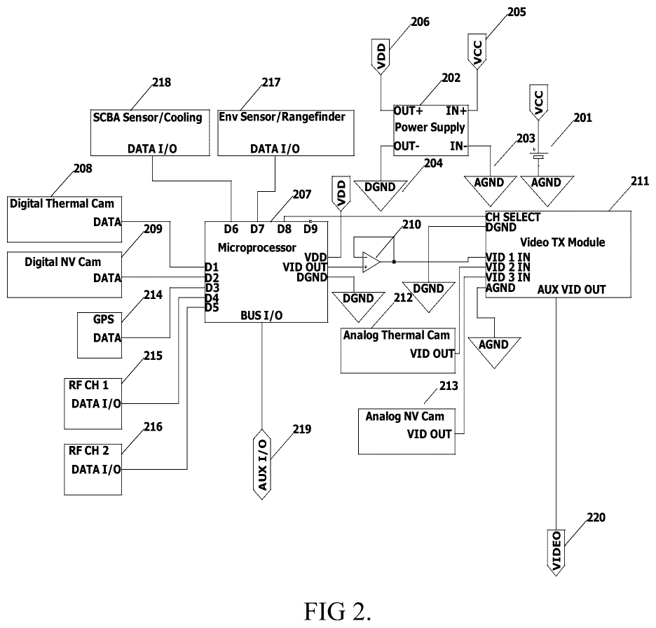

FIG. 2 depicts the MUM-T microprocessor interface 101 as shown in FIG. 1. The power supply consists of one or more batteries 201 and one or more DC-DC isolation step down converters (e.g. buck converter) 202. The entire circuit has a separate analog ground (“AGnd”) 203, digital ground (“DGnd”) 204, analog side supply voltage (“Vcc”) 205, and digital side supply voltage (“Vdd”) 206. The digital voltage is used to power the microprocessor 207 and all digital logic peripheral devices (e.g. USB, TTL/UART, etc.) The analog power supply is used for analog transmitters and analog cameras, sensors and other devices.

The microprocessor takes inputs from both one or more digital LWIR cameras 208 and digital adaptive night vision cameras 209 and outputs the video as a composite signal to an isolated line driver 210. The line driver then outputs the isolated analog video signal to a multiplexed multi-band, multi-channel video transmitter module 211. The other inputs to the video transmitter module are one or more analog LWIR cameras 212 and analog adaptive night vision cameras 213. In case the microprocessor fails, the analog cameras will still transmit video over the video transmitter module as a redundancy backup. The active channel and selected video feed are controlled by the microprocessor.

In addition, the microprocessor is connected to one or more GPS transceivers 214, one or more RF transceivers 215 and at least one backup RF transceiver 216. The RF transceivers are used for remote control sending and receiving commands, telemetry for location and environmental sensor and rangefinder 217 data, distress signals, and RSSI triangulation as a redundancy for GPS. The rangefinder data includes but is not limited to SONAR, LIDAR, and RADAR data. With multiple RF transceivers, remote controls and telemetry have redundancy as well. Remote control operation includes navigation as well as positioning and operation of tool attachments including but not limited to saws, hydraulic tools, and hoses. The whole unit is sealed off from the external IDLH environment and is cooled by air from the SCBA through an SCBA sensor and cooling module 218. The microprocessor can monitor pressure and flow on air from SCBA, therefore predicting when a firefighter will need to turn back or is in trouble. Every RF transceiver and video band will have designated emergency channels for MAYDAY and emergency traffic. The MUM-T microprocessor interface has one or more auxiliary high-density ports 219 for wired connection for compatible unmanned vehicles and manned attachments such as monitors, remote controls, external sensor modules, etc. The external auxiliary high density port gives a hard-wired interface for unmanned CNC vehicles allowing for navigation and operation of tool attachments. A second auxiliary port 220, preferably a coaxial connector that is shielded and environment resistant, is used to output composite analog video signals from the multiplexer and transmitter module allowing for a hard-wired video connection with external displays.

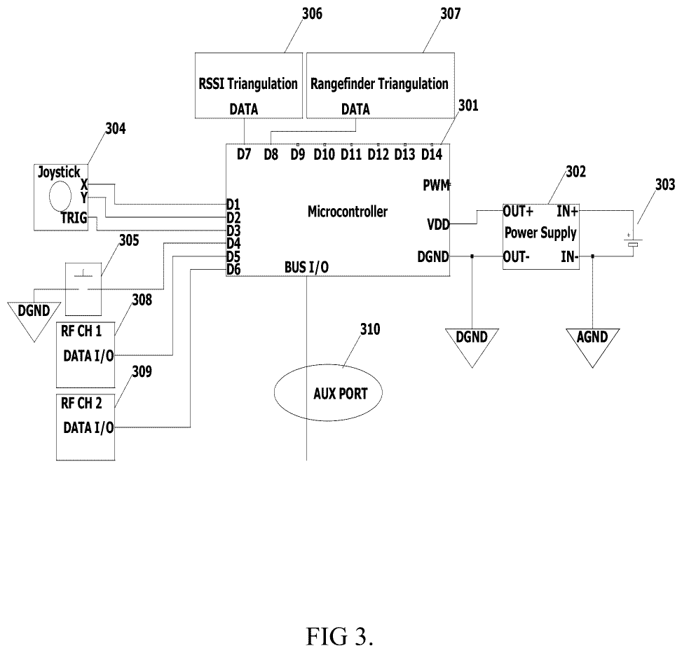

FIG. 3 depicts the user control microprocessor interface used for remote control 105 of a drone as well as triangulation as a strictly manned device as shown in FIG. 1. The interface consists of a microcontroller 301 fed by one or more DC-DC isolation converter 302 fed by one or more batteries 303. The microcontroller takes inputs from a joystick with a trigger button 304 and at least one momentary push button switches 305 to toggle selections and configurations (e.g. camera view, channel selection, etc.) The microcontroller also takes input from at least one RSSI triangulation module 306 and at least one rangefinder signal triangulation module 307. The RSSI triangulation module can triangulate other RF transceivers by signal strength while the rangefinder triangulation module uses the echo signal of other rangefinders (e.g. SONAR, LIDAR, RADAR, etc.) This can be used in tandem with GPS for locating either a firefighter or an unmanned vehicle. The microcontroller is connected to two separate RF channels 308 and 309 for both a remote control and full duplex telemetry. In addition, the microcontroller user interface has one or more high-density ports for compatible attachments.

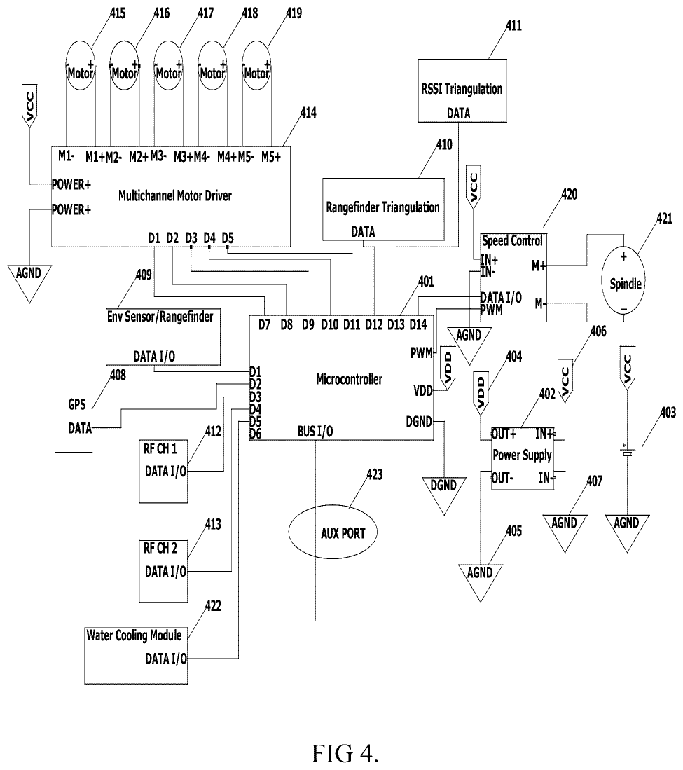

FIG. 4 depicts the unmanned vehicle microcontroller interface 103 as shown in FIG. 1. The microcontroller 401 is powered by one or more DC-DC isolation converter 402 and batteries 403. The digital power supply (Vdd) 404 and digital ground (DGnd) 405 are kept galvanically isolated from the analog battery power supply (Vcc) 406 and analog ground (AGnd) 407. The microcontroller is connected to GPS unit 408, and environmental sensors and rangefinder modules 409. This gives the microcontroller its location as well as mapping out walls and obstacles with the rangefinders. RSSI triangulation module 410, and rangefinder triangulation module 411 provide triangulation of location of other unmanned vehicles and firefighters. The unmanned vehicle can be autonomous or operated via remote control.

RF transceivers 412 and 413 operating on separate channels are used for telemetry, providing geospatial and environmental sensor data, and receiving commands from the remote-control user interface for both navigation and tool operation. The microcontroller takes the input from the RF transceivers and uses it to control a multiple motor driver 414. In this embodiment, these motors are used for positioning along three axes. In this embodiment of the invention, some of the motors are used for driving, moving, positioning, and steering a terrestrial continuous tread unmanned vehicle. At least three of the motors are used to position along the x, y, and z-coordinates and linear displacement of any attachments on the unmanned vehicle (e.g. saws, hydraulic tools, hose, etc.) A separate speed controller 420 is used to control the spindle motor 421 and get feedback (e.g. tachometer). The spindle can accept different attachments and even gear boxes. Since the unmanned vehicle will conceivably enter even harsher environments than a human firefighter, it is equipped with a water-cooling interface 422 that matches the dual use cooling system on the MUM-T interface. The unmanned vehicle also has a matching high-density aux port 423 for the digital I/O bus to match the MUM-T interface. This allows for hardwired direct control over the microcontroller and motors for navigation as well as tool attachment by the attached MUM-T module.

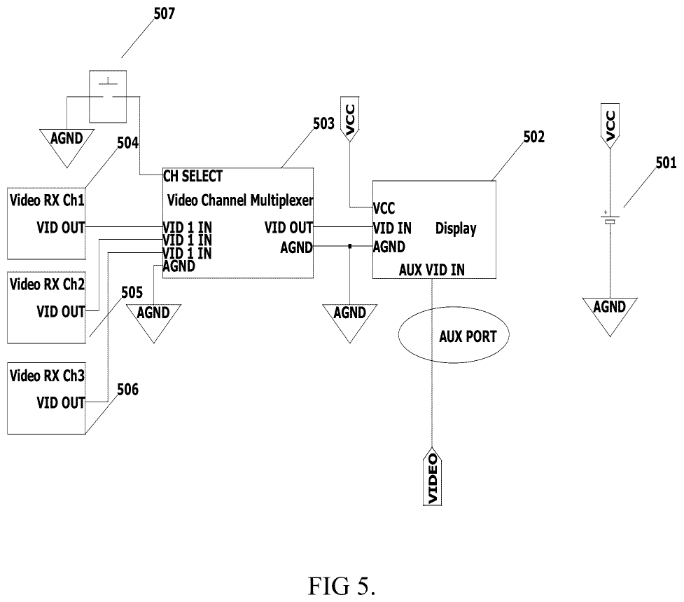

FIG. 5 depicts the video display and receiver circuit HUD 102 shown in FIG. 1. A battery power source 501 powers all components in this circuit. A display 502 is fed by a multiplexed video receiver module 503 that takes inputs from video receivers 504, 505, and 506 that are independent video channels and are preferably distributed over multiple bands for redundancy and failsafe operation. At least one channel is designated for a MAYDAY video feed. The operator can select the channel to view either their own point of view, another firefighter (e.g. subordinates, downed firefighter calling MAYDAY), or the video feed of an unmanned vehicle. Every MUM-T node 101 in FIG. 1 is compatible with the video receivers. The operator uses one or more push buttons 507 and/or other user interface controls for selecting the channels. On the channel, the corresponding video feed and any other configured on-screen inputs are displayed to the user. The HUD unit 102 can be either body worn in the field (e.g. helmet or mask mounted) or maybe a remote command and control center. When configured for a CNC unmanned vehicle, views can switch between navigation and tool operation.

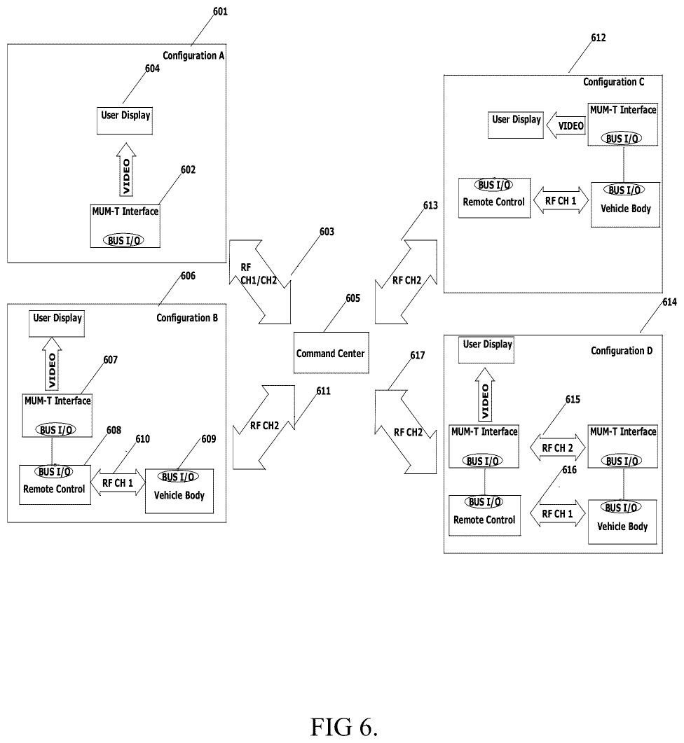

FIG. 6 depicts the general RF interactions between the MUM-T interface 101 and various components of the system. In configuration A 601, there is no unmanned vehicle and the MUM-T interface 602 uses all channels 603 to communicate telemetry, geospatial and video data to the user display 604 and remote command center 605. In configuration B 606, the MUM-T node is attached to the unmanned vehicle operator and optionally wired through the digital I/O aux port 607 to remote-control interface 608. The aux port allows power sharing and frees up channels for redundancy and other functions. The remote control sends commands to the unmanned vehicle 609 over at least one channel 610. The MUM-T node feeds video to the operator HUD and sends video and telemetry over remaining channels 611 to the remote command center. In configuration C 612, the MUM-T unit is mounted on the unmanned vehicle directly and feeds video and geospatial/sensor data back to the operator HUD display. The remaining channels 612 are used to send telemetry and video to the remote command center.

In configuration D 613, one MUM-T unit is body worn and paired with the remote control. The other is paired with the unmanned vehicle. One channel 614 runs parallel between the two MUM-T units and feeds the operator HUD while an identical control and telemetry channel 615 runs between the remote control and the unmanned vehicle. This means if the MUM-T unit fails, remote control of the unmanned vehicle will still work. If the unmanned vehicle fails, the remote cameras, geospatial features, and environmental sensors will still work conversely. The remaining channel 616 are used to send video and data to the remote command center.

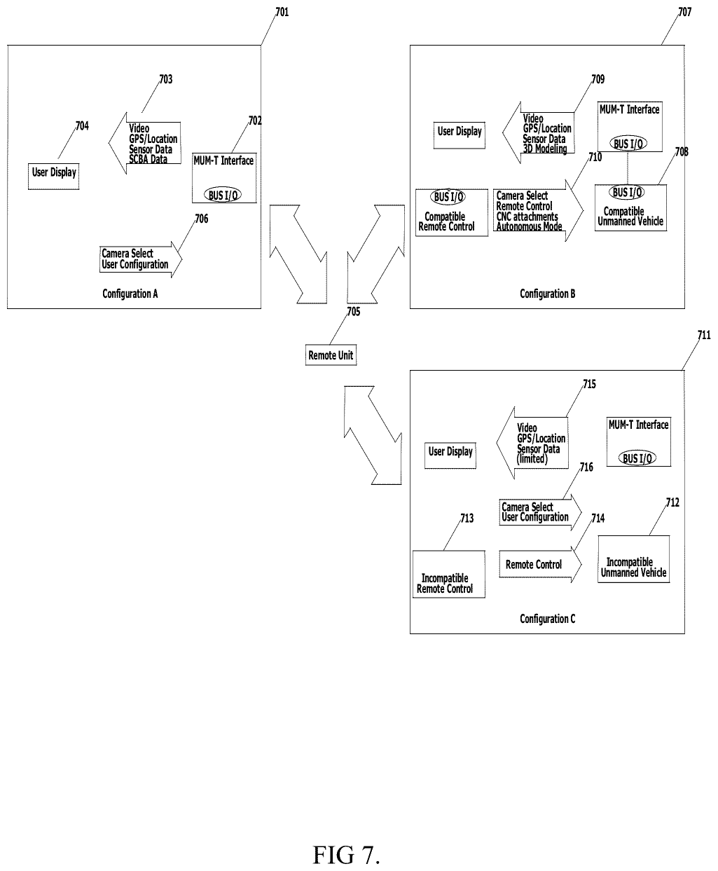

FIG. 7 depicts different levels of functionality depending on configuration. Configuration A 701 depicts the body worn only configuration as previously shown 601 in FIG. 6. In this configuration there is only one MUM-T interface module 702. There is no unmanned vehicle in so both video and all data from 703 the MUM-T interface module including but not limited to environmental sensors, GPS, rangefinders data are sent both to the display of the user wearing the device 704 and remote units 705 (both other firefighters and remote command centers.) Additional data specific to the manned configuration such as SCBA pressure and flow is also sent to the user and remote stations. From the display interface 706 to the MUM-T interface module, the user can toggle camera views and interact with the MUM-T interface user configuration.

Configuration B 707 shows the “full feature” mode a MUM-T unit coupled with a compatible unmanned vehicle 708. Full feature unmanned mode allows for autonomous operation with the microprocessor being able to control the microcontroller on board the unmanned vehicle. The unmanned vehicle is able to be directly controlled by the remote control as a redundancy. The full feature model also allows for sensor and rangefinder data collected by the unmanned vehicle microcontroller interface to be used by the MUM-T interface in conjunction with or in addition to imaging to create a 3D model for its surroundings. In addition, computer numerical control (CNC) operation of unmanned vehicle attachments can work in tandem with the 3D modeling and/or user control interface. Data sent from the MUM-T interface module to the user display 709 includes but is not limited to video, GPS, environmental sensor data, rangefinder data with for 3D modeling. Data sent from the user remote control to the MUM-T unit and unmanned vehicle 710 includes remote commands, user configuration, toggling camera, autonomous operation (e.g. setting an autonomous waypoint), and CNC control of positioning the vehicle and any tool attachments.

In configuration C 711, a MUM-T unit is physically secured to a MUM-T incompatible unmanned vehicle 712. A reduced function remote control is used for configuration of the MUM-T display and toggling cameras. The matching remote control 713 paired with the MUM-T incompatible unmanned vehicle is used for wireless remote control 714 for the unmanned vehicle. The MUM-T unit sends video and data 715 to the user display, environmental sensor data, rangefinder data, and geospatial location data to the user display. However advanced features mentioned before such as autonomous operation, 3D modeling, direct hard wiring of auxiliary ports (and thus reduced channels and redundancy features) are not available for MUM-T incompatible unmanned vehicles. The user display can send commands 716 to toggle cameras and configure the MUM-T interface module.

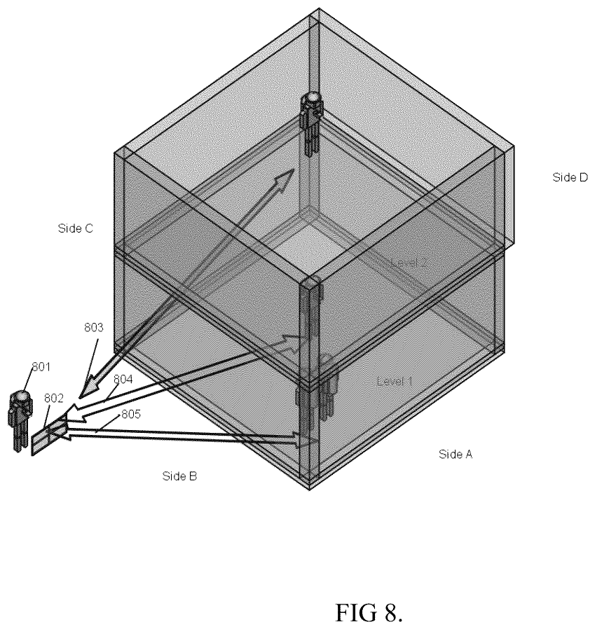

FIG. 8 depicts the high-level strategic diagram of the interactions between a remote command post and several interior firefighters for geospatial tracking, audio, video, and remote command and control. An officer 801 is stationed at a mobile command post 802 with one or more displays and/or split screen monitors. For teams such as the two firefighters in the AB corner of level 1 in the building, the command can decide to use one or more channels 803 for an AV feed, two-way communication, geospatial data, environmental sensor data, etc. The same channels can be used to send commands via methods including but not limited to audio and video to the interior firefighting team. In the case that the team is temporarily divided such as in the team pictured on level 2, independent AV and RF channels for each firefighter 804 and 805 can be used for AV monitoring and other RF interactions. The command post can handle multiple parallel video, audio, and RF telemetry channels from multiple MUM-T node sources including but not limited to individual firefighters, teams, and unmanned vehicles. In turn the officer at the command post can assume first person perspectives of individual interior firefighters and robots. He/she can also send remote audiovisual commands to both human firefighters and remote control to robots and receive geospatial data from different nodes including the GPS location and triangulation of RSSI and rangefinder signals, motion sensor data providing speed and direction, and rangefinders giving the relative location of barriers and walls.

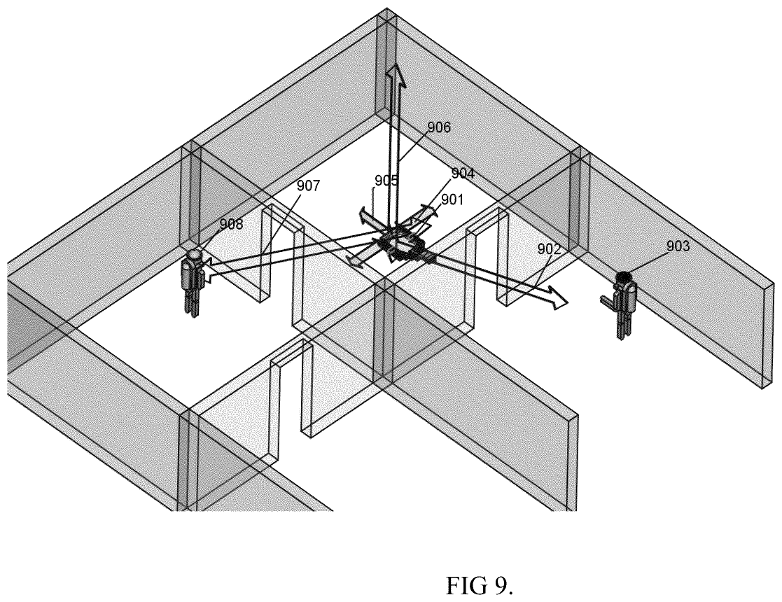

FIG. 9 depicts the unmanned vehicle entering a room, scanning it with rangefinders and other sensors, and setting a waypoint with geospatial data. The unmanned CNC vehicle 901 has one or more bidirectional duplex RF channels including AV 902 linking it to the operator 903. The RF channels are used to maneuver it into an enclosure in a structure such as a room. Once inside the room, it can use rangefinders for mapping out the x axis 904, y axis 905, and z axis 906 boundaries and walls/ceilings/floors. The geospatial data can then be sent to other firefighters 907 over other RF telemetry channels. Data includes but is not limited to GPS/GNSS coordinates, rangefinders readings, environmental sensors, and accelerometer data. The RF signals can be further triangulated by either a single firefighter (if the unit has three or more receivers or transceivers) or shared amongst different nodes including firefighters and unmanned vehicles alike. Operation of the unmanned vehicle may be remote controlled, autonomous, or semi-autonomous. The combination of geospatial location data with the rangefinders and sensors allows for further shortest path algorithms and other computer aided command decision making.

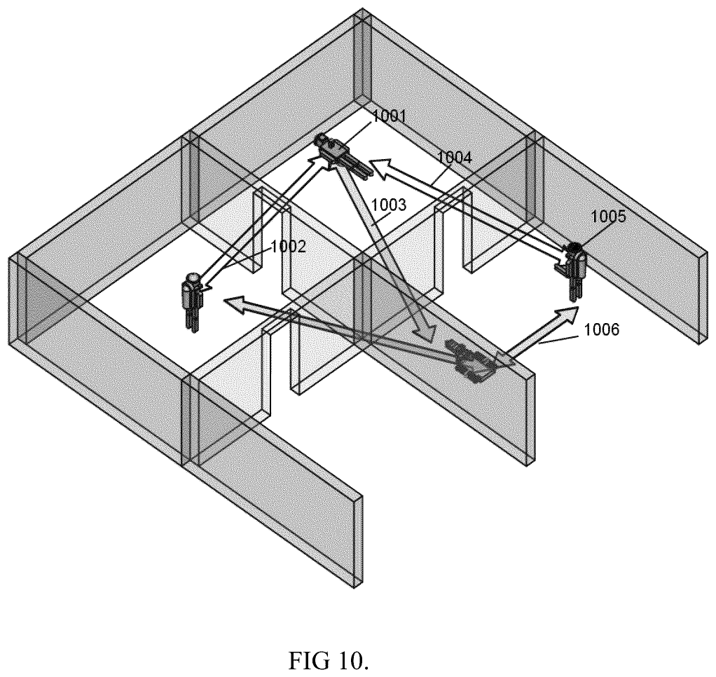

FIG. 10 depicts a firefighter in distress and an active MAYDAY operation with both firefighters and one or more unmanned vehicles. The firefighter in distress 1001 originally sends out pr an RF distress signal to other firefighters 1002 and either directly to unmanned vehicles 1003 and/or to operators of unmanned vehicles 1004 on designated emergency traffic channels. All remaining unrelated radio traffic is transmitted on other channels between firefighters and between unmanned vehicles and firefighters 1005. In the preferred embodiment, emergency traffic will take precedence over regular traffic on any given band, channel, protocol, etc. and a “silence” order will be issued except for emergency communication. The distress signal will broadcast the GNSS coordinates, the AV feed of the body worn MUM-T unit on the firefighter in distress and be used to triangulate the position of the downed firefighter. Unmanned vehicles may be either controlled remotely by designated operators 1006 or autonomously using geospatial location data. Department SOPs can be integrated including but not limited to periods of observed radio silence during a MAYDAY scenario and allocation of bands of RF including AV as designated emergency traffic channels.

A plethora of variations and derivatives will be apparent to those skilled in the field of the invention. The particular embodiment described is only meant for illustrative purposes and in no way limits the scope of the invention. The claims should be referenced for the scope of the invention rather than the detailed description. Other embodiments may include semi-autonomous models where the operator enters a waypoint and the CNC vehicle navigates automatically to the user defined location. In a limited functionality mode, for unmanned vehicles without a compatible interface, the MUM-T module can still be affixed to the unmanned vehicle for additional vision, geospatial, rangefinder, and environmental sensor data.

### GLOSSARY

Side A, B, C, and D: A is the building side facing the street. B,C, and D are labeled counterclockwise.

Level 1, 2: Level 1 is ground floor and level 2 is second floor of a building. A building may have one or more levels.

RF: Radio frequency signals including AV signals

GNSS: Generic Global Navigation Satellite Systems including GPS and other satellite-based geolocation services. Used interchangeably with GPS in this application.

GPS: Global Positioning System. Satellite based GNSS system operated and maintained by the US government. Used interchangeably with GNSS.

LWIR: Long wave infrared. Denotes a camera and/or image sensor capable of sensing the longer wavelength portion of the infrared spectrum. Used interchangeably with thermal imaging.

Audio: Sound transmitted via digital and/or analog RF channels.

Video: Image data sent via analog or digital RF channels.

AV-Audiovisual: Represents a feed of both audio and video data.

Transceiver: RF module capable of both transmitting and receiving

Band: RF frequency range used for a specific RF application. Examples include but are not limited
433 MHz, 915 MHz, and 2.4 GHz for remote control
1.2 Ghz, 2.4 Ghz, and 5.8 Ghz for AV

RSSI: Received signal strength index. A quantified measure of signal strength for an RF source.

RSSI triangulation—uses at least three receiving points measuring RSSI from a remote RF source and based on calibrated signal strength, uses a spatial algorithm to locate the source of an RF transmission.

Geospatial data: Location data including but not limited to GPS, other GNSS systems, RSSI triangulation (on multiple bands and channels including the telemetry channels used to send remote GNSS coordinates.)

SCBA—Self-contained breathing apparatus. Usually, a body worn unit for respiratory protection in a hazardous environment.

IDLH—Immediately dangerous to life and health. Typically, a structural fire, wildland fire, HAZMAT incident, or another emergency/disaster requiring specialized first responders and personal protective equipment including the SCBA.

MAYDAY—Indicates that the firefighter/first responder is in distress and in dire need of assistance. It can be initiated by the firefighter in distress, another firefighter, or automatically by sensors such as but not limited to accelerometers.

Emergency traffic: RF signals sent to or from a MAYDAY location such as a distressed firefighter. This type of RF traffic takes priority on emergency bands of RF.

Regular traffic: Regular RF signals at the scene of an emergency. This may include but is not limited to video, audio, text, data and geospatial information.

Firefighter: Includes a structural, wildland, marine, or aircraft firefighter. This term is used interchangeably with first responder.

First Responder: Indicates a member of emergency services properly trained and equipped for operating in an IDLH environment.

Rangefinder: Consists of a signal emitter and receiver. Bounces signal off a remote object and measures time needed to receive the echo to calculate distance. Includes but not limited to SONAR (ultrasound), RADAR (RF), LIDAR (laser)

MUM-T: Manned-Unmanned teaming. The integration and teaming of human personnel and unmanned vehicles and robots.

Unmanned vehicle: used interchangeably with robot

CNC: Computer numerical control. Denotes a machine with linear and rotational axes that can be used for positioning tools and attachments. In the embodiment described, this can be taken to be inclusive of navigation and maneuvering of the unmanned vehicle chassis itself as well as positioning and operation of any attached tools.

What is claimed:

1. A Manned-Unmanned (MUM-T) system for firefighting and related rescue purposes comprising of both manned and unmanned components consisting of:
a. One or more MUM-T interface modules;
b. One or more firefighters;
c. One or more unmanned CNC vehicles;
d. One or more firefighters trained as unmanned vehicle operators;
e. One or more mediums allowing for visual monitoring;
f. One or more remote controls;
g. One or more control mediums allowing communication and interface between firefighters and body mounted units, remote controlled unmanned CNC vehicles, firefighter to firefighter, firefighter to unmanned vehicle, and unmanned vehicle to unmanned vehicle interactions.

2. A system of claim 1 wherein the MUM-T interface module can be either configured for manned (e.g. body worn) or unmanned (CNC vehicles) configurations.

3. A system of claim 1 wherein the MUM-T interface is an independent portable device or medium with redundancy for power, AV channels, RF channels and other functionalities.

4. A system of claim 3 wherein the MUM-T module is powered by one or more mobile power supplies.

5. A system of claim 3 wherein the MUM-T module contains one or more microprocessors or microcontrollers.

6. A system of claim 3 wherein the MUM-T module contains one or more digital and/or analog imaging capabilities for temperature and other environmental factors capturing and processing.

7. A system of claim 3 wherein the MUM-T module contains one or more digital and/or analog image capturing capabilities for operating normal light, limited light, or no light situations.

8. A system of claim 3 wherein the MUM-T module contains one or more AV transmitters covering different bands and channels for audio and video transmission.

9. A system of claim 3 wherein the MUM-T module contains one or more RF transceivers capable of telemetry, remote control, and RSSI triangulation linked to the microprocessor.

10. A system of claim 3 wherein the MUM-T module contains one or more signal rangefinder transducers with the ability to triangulate signal from a remote source.

11. A system of claims 9 and 10 wherein RSSI and signal rangefinder triangulation can be done with one or more devices with three or more receivers between them.

12. A system of claim 3 wherein the MUM-T module contains one or more active GPS/GNSS receivers linked to the microprocessor.

13. A system of claim 3 wherein the MUM-T module contains a cooling system capable of either using SCBA air or pumped fluid as a coolant.

14. A system of claims 1 and 3 wherein the MUM-T module contains one or more external high-density connectors allowing for a data connection between a MUM-T module and a CNC vehicle.

15. A system of claim 1 wherein the robotic CNC vehicle is compatible with the MUM-T module and capable of autonomous, semi-autonomous, or manual remote control.

16. A system of claim 15 wherein the robotic CNC vehicle can take attachments for power and/or hydraulic tools.

17. A system of claim 15 wherein the robotic CNC vehicle contains a mobile power supply.

18. A system of claim 15 wherein the robotic CNC vehicle contains one or more microprocessors and/or microcontrollers.

19. A system of claims 1, 9, and 15 wherein the robotic CNC vehicle has matching transceivers that are compatible with the MUM-T module and remote control.

20. A system of claim 18 wherein the microprocessor/microcontroller controls motors for navigation, attachment positioning and motor throttle (e.g. saw motor, etc.) for the tool attachment.

21. A system of claim 18 wherein the CNC unmanned vehicle microcontroller interface has extra environmental sensors and rangefinders for redundancy.

22. A system of claim 1 wherein each user has a display for video feed that allows them to view imaging and video data from different nodes (e.g. first person, third person, unmanned).

23. A system of claim 22 wherein the display module allows user selection and configuration of the AV channel selected.

24. A system of claim 8, 22, 23 wherein the AV channels have certain channels for regular traffic with others reserved strictly for MAYDAY/emergency traffic.

25. A system of claim 1 wherein a remote-control module is assigned to each operator for each unmanned CNC vehicle.

26. A system of claims 1, 15, and 25 wherein the operator can either manually control or enter parameters for the CNC vehicle operation for either semi-autonomous or autonomous operation.

27. A system of claim 1 wherein certain channels are designated for emergency traffic and SOPs include radio silence for MAYDAY or firefighter in distress signals.
